(19) United States
(12) Patent Application Publication
(10) Pub. No.: US 2003/0202701 A1
(43) Pub. Date: Oct. 30, 2003

(54) Method and apparatus for tie-point registration of disparate imaging sensors by matching optical flow

(76) Inventor: Jonathon Schuler, Fairfax, VA (US)

Correspondence Address: NAVAL RESEARCH LABORATORY, ASSOCIATE COUNSEL (PATENTS), CODE 1008.2, 4555 OVERLOOK AVENUE, S.W., WASHINGTON, DC, 20375-5320, US

(21) Appl. No.: 10/113,641

(22) Filed: Mar. 29, 2002

(51) Int. Cl. G06K 9/62

(52) U.S. Cl. 382/209; 382/276

(57) ABSTRACT

A method and apparatus for enabling the registration of co-located, disparate imaging sensors by computing the optical flow of each sensor as all the sensors simultaneously observe a moving object, or as all the sensors simultaneously move observing an object. The tie point registration of disparate imaging sensors is made more robust by matching optical flow and by levering the temporal motion within a pair of video sequences and using an additional constraint to minimize the disparity in optical flow between registered video sequences. The method includes parametrically computing the optical flow of each video sequence separately relative to a reference frame pair, identifying a matching constellation of tie-points in the reference pair of images, for all frames, computing the positions of tie-points bᵢ=b₀+eᵢ where eᵢ=predictive term to generate a new set of tie-points, after transformation by optical flow. For each frame, the total squared error resulting from an over-determined solution of affine registration problem is computed. The choice of eᵢ is adjusted to minimize the total squared error over all frames of video.

### BACKGROUND OF THE INVENTION

1. Field of the Invention

This invention relates to imaging systems, and more particularly, to a robust method for tie-point registration of disparate imaging sensors by matching the optical flow contained in the temporal motion within a pair of video sequences. This is achieved by minimizing the disparity in optical flow between registered video sequences.

2. Description of Related Art

Image registration techniques play an important role in terrain assessment, mapping, and sensor fusion. A majority of the imaging systems include a combination of distinct electro-optical sensors that are constrained to view the same scene through a common aperture or from a common platform. Most often, a spatial registration of one sensor's image is required to conform to the slightly disparate imaging geometry of a different sensor on the same platform. The spatial registration is generally achieved through a judicious selection of image tie-points and a geometric transformation model. From a sequence of spatially overlapping digital images, image registration techniques interpolate pixel intensities to coordinates identified by the registration model, and automatically register points of correspondence (“tie-points”) among the plurality of images.

Consider the initial problem of registering two images, for example, A and B, by interpolating image A onto a new set of coordinates that align with image B, i.e., this process aligns image A onto a base image B. This alignment may be initially achieved through an operator-supervised selection of tie-points that are common to both images A and B, and then fitting such tie-points to a parametric model relating coordinates between the two images A and B. The selection of n such tie-points with (x, y) coordinates in each image generates two n×2 matrices of position data as follows:

$$\underline{\underline{A}} = [ \begin{matrix}{y}_{a , 1} & {x}_{a , 1} \\ {y}_{a , 2} & {x}_{a , 2} \\ ⋮ & ⋮ \\ {y}_{a , n} & {x}_{a , n}\end{matrix} ] = [ \begin{matrix}\underline{{Y}_{a}} & \underline{{X}_{a}}\end{matrix} ] \underline{\underline{B}} = [ \begin{matrix}{y}_{b , 1} & {x}_{b , 1} \\ {y}_{b , 2} & {x}_{b , 2} \\ ⋮ & ⋮ \\ {y}_{b , n} & {x}_{b , n}\end{matrix} ] = [ \begin{matrix}\underline{{Y}_{b}} & \underline{{X}_{b}}\end{matrix} ] \qquad ( 1 )$$

Limiting the consideration to affiance transformations that relate to these tie points results in the following:

$$[ \begin{matrix}1 & {y}_{a , 1} & {x}_{a , 1} \\ 1 & {y}_{a , 2} & {x}_{a , 2} \\ ⋮ & ⋮ & ⋮ \\ 1 & {y}_{a , n} & {x}_{a , n}\end{matrix} ] [ \begin{matrix}{S}_{y} & {S}_{x} \\ [ R & {}_{2 \times 2} ] \end{matrix} ] = [ \begin{matrix}{y}_{b , 1 } & {x}_{b , 1} \\ {y}_{b , 2} & {x}_{b , 2} \\ ⋮ & ⋮ \\ {y}_{b , n} & {x}_{b , n}\end{matrix} ] [ \begin{matrix}\underline{1} & \underline{\underline{A}}\end{matrix} ] [ {R}_{T} ] = [ \underline{\underline{B}} ] \qquad ( 2 )$$

where R_{T}=transformation model for matching tie-points of image A with tie-points of image B.

The algebraic model described in equation (2) requires 3 pairs of tie-points to determine a unique solution. Additional tie-points create an over-determined set of equations whose solution is considered to be an unconstrained linear least squares fit.

FIGS. 2 and 3 illustrate simultaneous imagery captured in the visible and infrared spectral bands. Overlaid on these images is a manually selected constellation of 12 tie-points used for subsequent registration. Specifically, FIG. 2 illustrates an infrared image and tie-points. This image is used as a base image B in the alignment procedure. FIG. 3 illustrates a visible image and tie-points. This image (“image A”) is subsequently warped to a new set of coordinates for subsequent fusion with the base image B. Given the two sets of tie-points and subsequent least-squares fit to an algebraic transformation model the measured intensities of image A are warped by standard interpolation algorithms, that are not the subject of this patent application, and are therefore not discussed herein, onto a new set of coordinates so as to align with image B.

FIG. 4 demonstrates the registration of image A onto image B through a simple fusion of the aligned data set and highlights the spatial registration of features unique to each constituent image.

FIGS. 5 and 6 illustrate the process of steps needed to register images A and B for such a fusion process. A set of tie-points is hand-picked in images A and B as illustrated at steps 502 and 504. A parametric model as illustrated by equation (2) is defined to relate coordinates between images A and B, and this process is illustrated at step 506. Images A and B are warped/registered through a simple fusion process as illustrated at step 508.

The method of registration described in FIGS. 2 through 6 requires determining a set of tie-points in each image, and then computing a generalized coordinate map between pixels of each sensor. This method is limited by the accuracy of tie-point selection, as well as by practical limitations of selecting a reasonably few number of tie-points. Thus, there is a need for a more robust method of registering tie-points of disparate imaging sensors to overcome the problems associated with prior approaches.

### SUMMARY OF THE INVENTION

The present invention relates to a method and apparatus for enabling the registration of co-located, disparate imaging sensors by computing the optical flow of each sensor, as all the sensors simultaneously observe a moving object, or as all the sensors simultaneously move while observing an object.

More specifically, the tie point registration of disparate imaging sensors is made more robust by matching the optical flow measured within the specified temporal motion in a pair of video sequences. An implicitly constrained optimization search seeks to minimize the disparity in optical flow between registered video sequences. The method includes the steps of (a) parametrically computing the optical flow of each video sequence separately relative to a reference frame pair; (b) identifying a matching constellation of tie-points in the reference pair of images; (c) for all frames, computing the positions of tie-points b₀ and aᵢ+a₀+eᵢ where eᵢ=predictive term to generate a new set of tie-points, after transformation by optical flow; (d) for each frame, computing the total squared error resulting from an over-determined solution of affiance registration problem; and (e) adjusting the choice of eᵢ to minimize the total squared error over all frames of video.

While the invention has been herein shown and described in what is presently conceived to be the most practical and preferred embodiment, it will be apparent to those of ordinary skill in the art that many modifications may be made thereof within the scope of the invention, which scope is to be accorded the broadest interpretation of the appended claims so as to encompass all equivalent methods and apparatus.

### BRIEF DESCRIPTION OF THE DRAWINGS

FIG. 1 illustrates an exemplary common sensor platform from which two sensors are registered;

FIG. 2 shows an infrared image and a set of tie-points selected on the image, the infrared image being used as a base image B in alignment procedure;

FIG. 3 shows a visible image and a set of tie-points selected on the image, the visible image A is subsequently warped to a new set of coordinates for fusion with the base image B as shown in FIG. 2;

FIG. 4 illustrates a monochrome fused composite of warped image A and base image B, highlighting the spatial registration of features unique to each constituent image;

FIG. 5 illustrates the various steps involved in registering images A and B through a simple fusion process as shown in FIGS. 2-4;

FIG. 6 is a schematic illustrating the registration of images A and B through a simple fusion process as shown in FIGS. 2-4;

FIG. 7 is a schematic illustrating the registration of images A and B by matching optical flow in accordance with an exemplary embodiment of the present invention;

FIGS. 8-9 are flowcharts illustrating the process steps involved in the registration of images A and B by matching optical flow in accordance with an exemplary embodiment of the present invention;

FIG. 10 is a schematic of an exemplary apparatus for performing image registration of images A and B in accordance with an exemplary embodiment of the present invention;

FIG. 10A illustrates exemplary details of the computer system shown in FIG. 10;

FIG. 11 illustrates an exemplary difference image between two frames of visible video;

FIG. 12 illustrates an exemplary difference image between two frames of infrared video;

FIG. 13 illustrates an exemplary optical flow field of the visible sensor identified in FIG. 11 and computed by multi-scale gradient estimation;

FIG. 14 is an exemplary illustration which shows a constellation of 12 tie-points relating to coordinates in visible and infrared imagery as identified in FIGS. 2 and 3 in accordance with an exemplary embodiment of the present invention;

FIG. 15 is an exemplary illustration which shows a constellation of 84 tie-points generated by evaluating the original 12 tie-points across seven transformations of estimated optical flow in accordance with an exemplary embodiment of the present invention; and

FIG. 16 illustrates an exemplary table showing an initial set of tie-points and their final adjustments in accordance with an exemplary embodiment of the present invention.

### DETAILED DESCRIPTION OF THE EXEMPLARY EMBODIMENTS

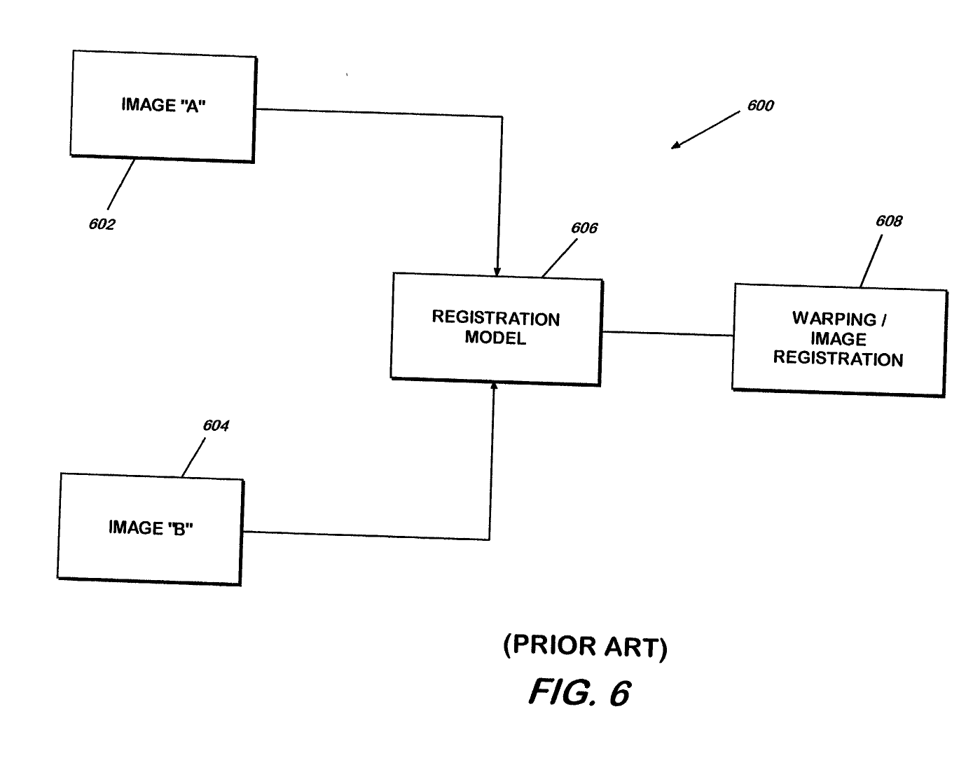

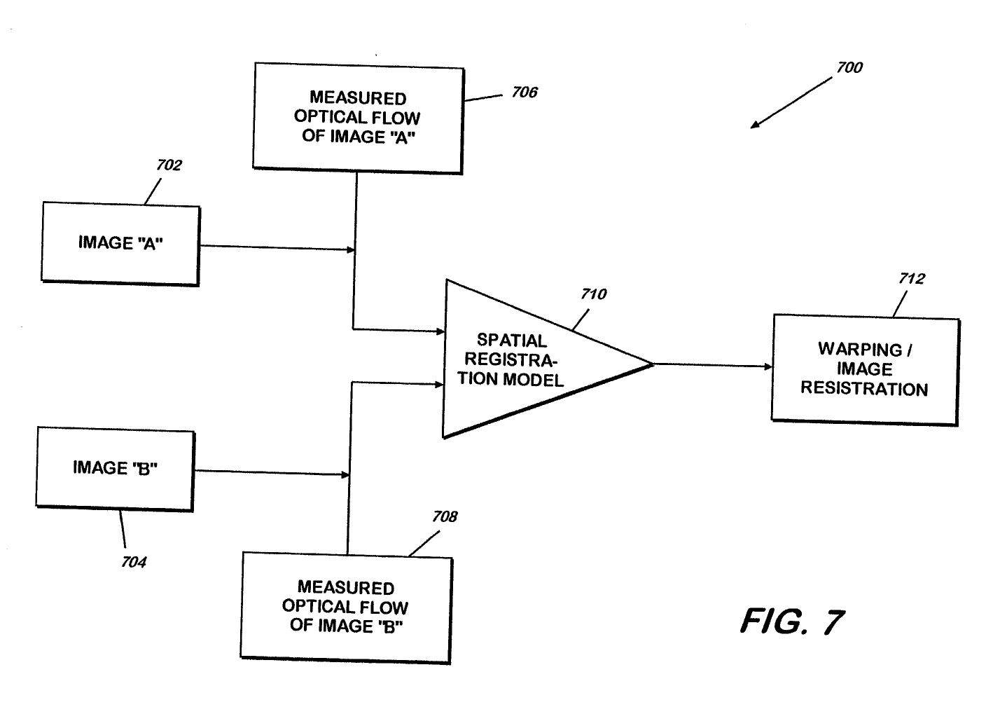

Referring now to FIG. 7, there is shown a schematic illustrating registration of images A and B by matching optical flow in accordance with an exemplary embodiment of the present invention. FIG. 7 identifies a similar set of tie-points in image A at 702 as those that are identified in image A depicted at 602 (FIG. 6). Likewise, a similar set of tie-points in image B is identified at 704. Subsequently, the optical flow of images A and B is measured at 706 and 708, respectively. The optical flow is defined as a description of how every pixel moves in a video sequence relative to some reference frame. Optical flow may be determined using a variety of means. For example, a camera may be moved or displaced around an object and the correlation between one frame and a subsequent frame in an image may be determined, whose well defined surface peak corresponds to the displacement between the two images A₀ and A₁. This is one exemplary approach to determine optical flow between two images. There may be other ways of determining the optical flow of an image. The present invention should not be construed to be limited to a particular method of determining an optical flow of an image.

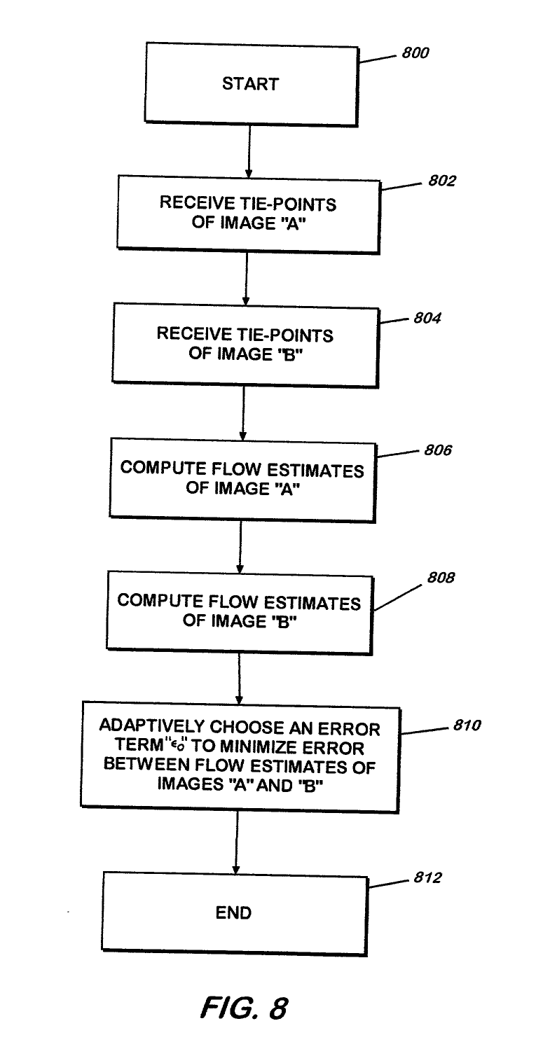

The measured optical flows of image sequences {A} and {B} are received in a spatial registration model identified at 710 having a transformation function of the form as illustrated in equation (2) and output from the spatial registration model is received by warping/image registration system 712. Given tie-points in image B as absolute, compute B₁, . . . Bₙ, where B₁ . . . Bₙ are the flow estimates of image sequence {B} and B₀ is the original, measured tie-points. Likewise, compute A₁, . . . Aₙ, where A₁, . . . Aₙ are the flow estimates of image sequence {A} and A₀+ε₀ are the original, measured tie-points that are presumed to contain an intrinsic measurement error. Adaptively choose a corrective term ε₀ to minimize the error between [A₀, A₁, . . . Aₙ] and [B₀, B₁, . . . Bₙ]. A flow chart corresponding to the above described process steps is illustrated in FIG. 8, and the process steps are identified at 800 through 812.

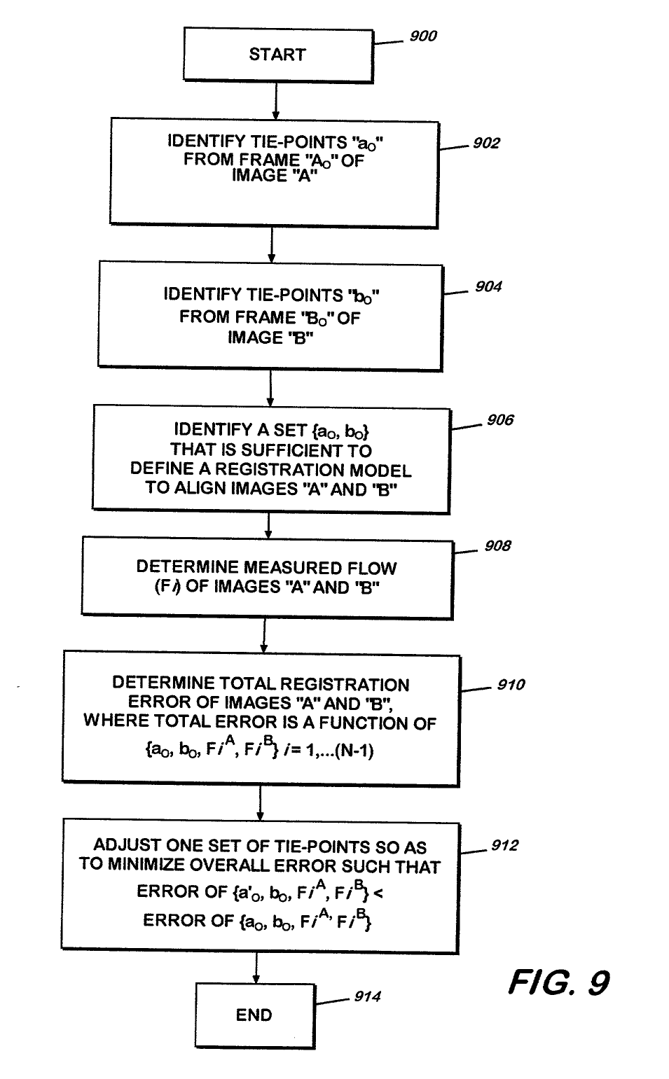

FIG. 9 shows a detailed flowchart illustrating registration details of images A and B in accordance with an exemplary embodiment of the present invention. In step 902, tie-points a₀ are identified from frame A₀ of image A. Likewise, in step 904, tie-points b₀ are identified from frame B₀ of image B. The set {a₀, b₀} may be sufficient to define a registration model to align images A and B as defined at step 906. Measured optical flow of images A and B is determined at step 908 and the total error of registration of images A and B is determined at step 910, where total error is a function of {a₀, b₀, Fᵢ^{A}, Fᵢ^{B}} where i=1, 2, . . . (N−1). At step 912, an optimization algorithm is used to adjust one set of tie-points a₀ so as to minimize error such that Error {a₀′, b₀, Fᵢ^{A}, Fᵢ^{B}}<Error {a₀, b₀, Fᵢ^{A}, Fᵢ^{B}}. For example, the Nelder-Mead algorithm is used to minimize the total error as illustrated in FIG. 9. It will be appreciated that other algorithms may also be used to minimize the total error.

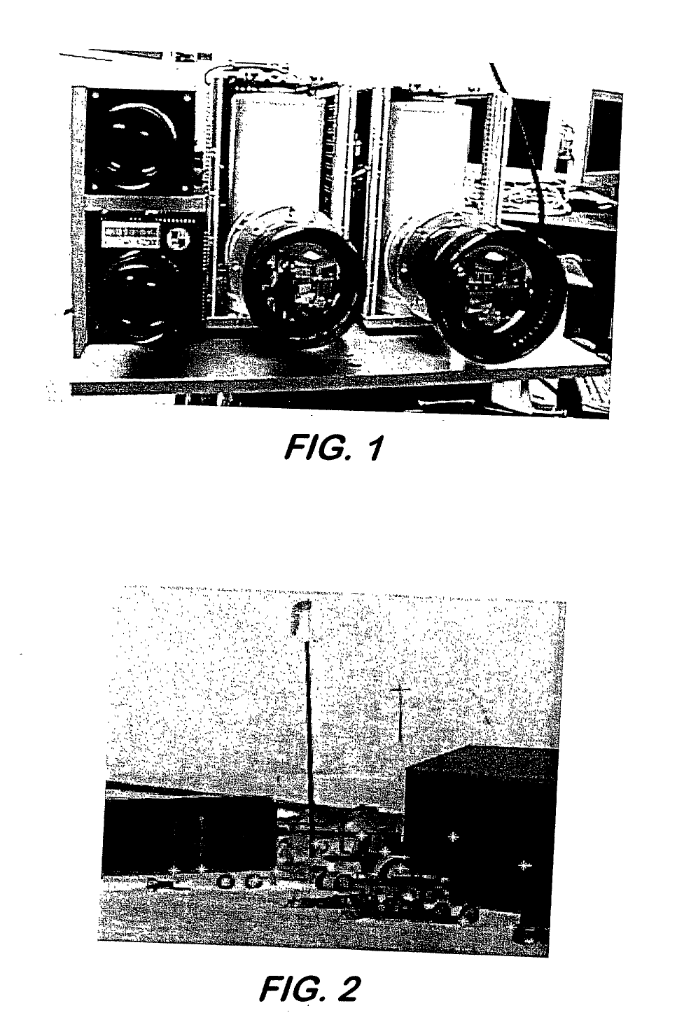

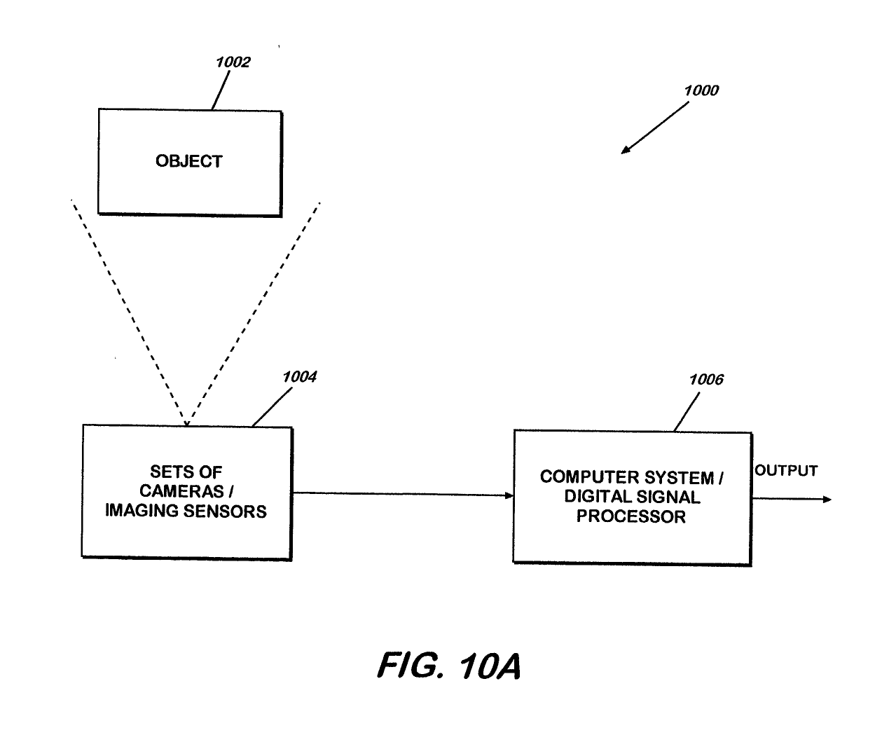

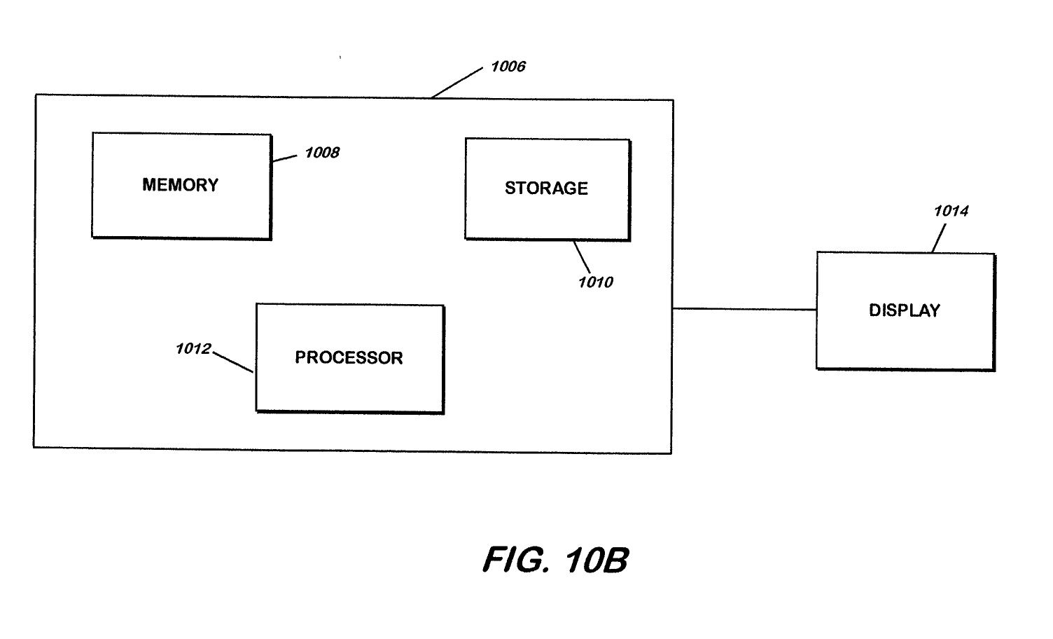

FIG. 10A is a schematic of an exemplary apparatus for performing image registration of images A and B in accordance with an exemplary embodiment of the present invention. A set of cameras 1004 may be used to observe an object and capture its image. For example, the set of cameras may include a visible camera, an infrared camera, a long wave camera, etc. as identified in FIG. 1 of the present invention. The captured images are fed to a computer system or a digital signal processor 1006 for further processing and image registration as described in FIGS. 7 through 9 of the present invention. The computer system 1006, the details of which are set forth in FIG. 10B, is a convention computer system having a memory 1008, a storage unit 1010, a processor 1012, and a display device 1014 for displaying images and the sequences of image registration.

Optical Flow Estimation

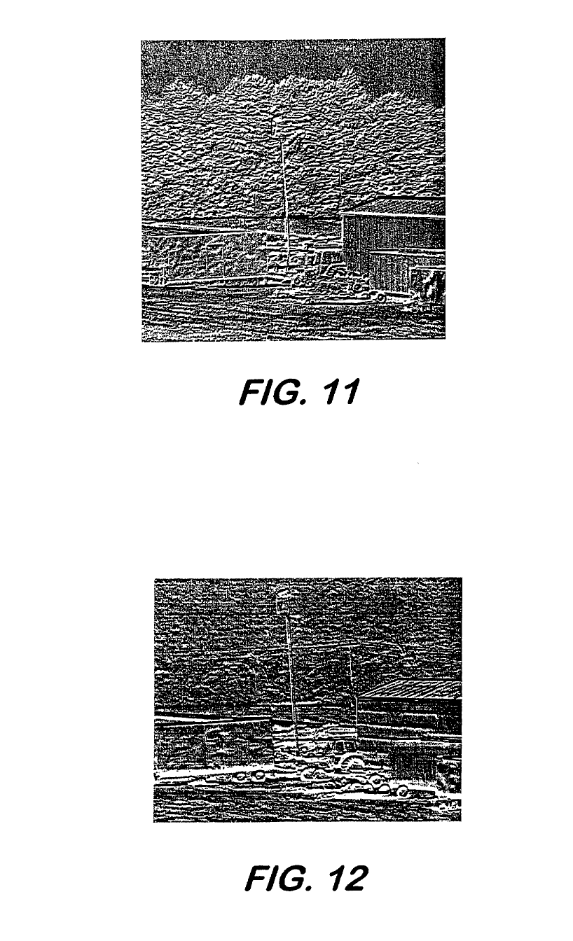

FIG. 11 shows an exemplary difference image between two frames of visible video. FIG. 12 illustrates an exemplary difference image between two frames of infrared video. Although the cross-registration of different imaging sensors in a multi-spectral sensor may require a supervised set of tie-points, frame-to-frame estimation of a video scene motion of any individual sensor may be autonomously computed by a multitude of shift-estimation techniques such as for example, multi-scale correlation or gradient estimation. For example, in the particular case of a dynamic sensor platform imaging a stationary scene, as illustrated in FIG. 1, with negligible cross-sensor parallax, the motion of the resulting video sequences may be characterized as a flow field parameterized by only the geometry of the camera motion and the spatial distortions of the camera optics.

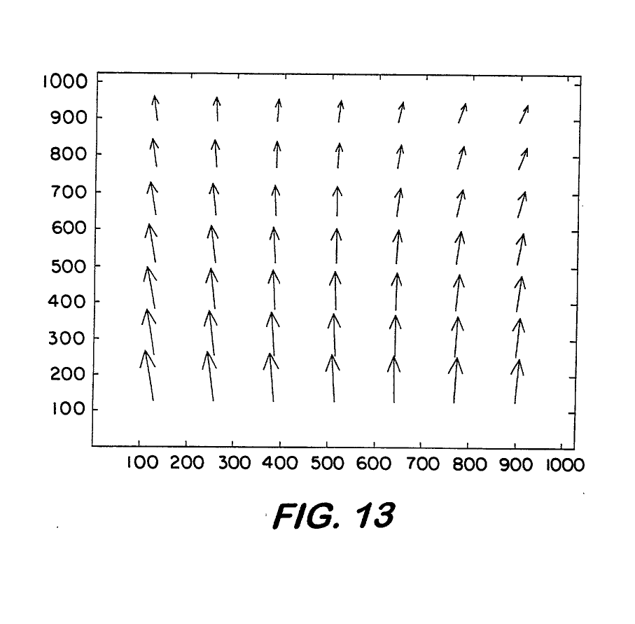

FIG. 13 illustrates an exemplary optical flow field of the visible sensor identified in FIG. 11 and computed by multi-scale gradient estimation. In this process, an exemplary multi-scale image-shift estimation method was used on both sets of video to generate parametric vector flow fields for each constituent video sequence. The structure of the field is primarily a uniform shift resulting from panning an image sensor upwards. Second-order structures result from a particular scene geometry and spatial lens distortion subject to such an upwards panning. Just as with the spatial registration by tie-points, such measured flow fields may be parametrically modeled so as to numerically generate a shift for any arbitrary coordinate in the image field. Applying, without loss of generality, a linear affiance model characterizing the local shift vector as a function of the arbitrary coordinate, a set of measured displacements a is collected, for example, by any motion estimation technique, at a given set of coordinates b.

$$\underline{\underline{S}} = [ \begin{matrix}Δ {y}_{1} & Δ {x}_{1} \\ Δ {y}_{2} & Δ {x}_{2} \\ ⋮ & ⋮ \\ Δ {y}_{n} & Δ {x}_{n}\end{matrix} ] = [ \begin{matrix}\underline{Δ Y} & \underline{Δ X}\end{matrix} ] \underline{\underline{C}} = [ \begin{matrix}{y}_{1} & {x}_{1} \\ {y}_{2} & {x}_{2} \\ ⋮ & ⋮ \\ {y}_{n} & {x}_{n}\end{matrix} ] = [ \begin{matrix}\underline{Y} & \underline{X}\end{matrix} ] \qquad ( 3 )$$

Assuming that these displacements are an algebraic function of image coordinates results in the following:

$$[ \begin{matrix}1 & {y}_{1} & {x}_{1} \\ 1 & {y}_{2} & {x}_{2} \\ ⋮ & ⋮ & ⋮ \\ 1 & {y}_{n} & {x}_{n}\end{matrix} ] [ {R}_{3 \times 2} ] = [ \begin{matrix}Δ {y}_{1} & Δ {x}_{1} \\ Δ {y}_{2} & Δ {x}_{2} \\ ⋮ & ⋮ \\ Δ {y}_{n} & Δ {x}_{n}\end{matrix} ] [ \begin{matrix}\underline{1} & \underline{\underline{C}}\end{matrix} ] [ F ] = [ \underline{\underline{S}} ] \qquad ( 4 )$$

As before, the unconstrained least squares fit as the solution to such an over-determined set of equations is accepted.

Autonomous Registration Based on Matching Optical Flow

Given two video sequences consisting of consecutive image pairs {Aᵢ, Bᵢ} i=0,1, . . . , n−1 for each separate imaging device, a set of parametric flow field matrices {Fᵢ^{A}, Fᵢ^{B}} i=1,2, . . . , n−1 as described in equations (3) and (4) is computed, relative to the video frame pair {A₀, B₀}.

Additionally, for the reference frame pair {A₀, B₀}, a set of feature tie points a₀ and b₀ is determined, as defined in equations (1) and (2). At the outset, an n-fold increase in the number of tie-points of image pair {A₀, B₀} may be achieved by evaluating their location in all subsequent image pairs {Aᵢ, Bᵢ} i=1, . . . , n−1 by the relation

aᵢ=a₀+└1 a₀┘Fᵢ^{A}

i=1,2, . . . , n−1

bᵢ=b₀+[1 b₀]Fᵢ^{B}

Thus, the registration problem can be redefined as the simultaneous least squares solution to aligning all candidate tie points:

$$[ \begin{matrix}\underline{1} & {\underline{a}}_{0} \\ \underline{1} & {\underline{a}}_{1} \\ ⋮ & ⋮ \\ \underline{1} & {\underline{a}}_{n}\end{matrix} ] [ \begin{matrix}{S}_{y} & {S}_{x} \\ R & {}_{2 \times 2} ]\end{matrix} ] = [ \begin{matrix}{\underline{b}}_{0} \\ {\underline{b}}_{1} \\ ⋮ \\ {\underline{b}}_{n}\end{matrix} ]$$

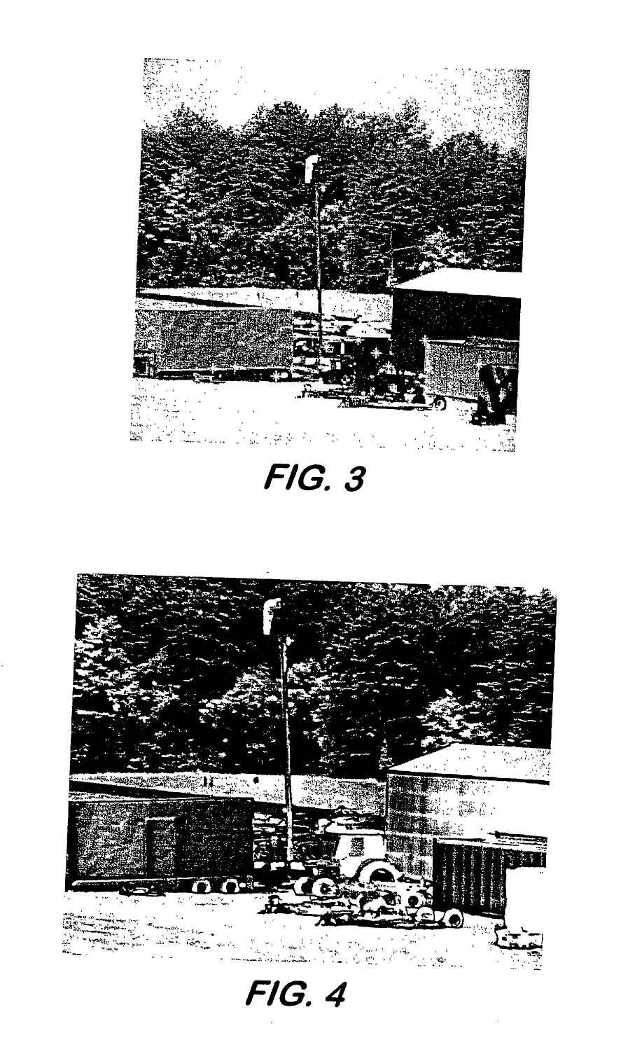

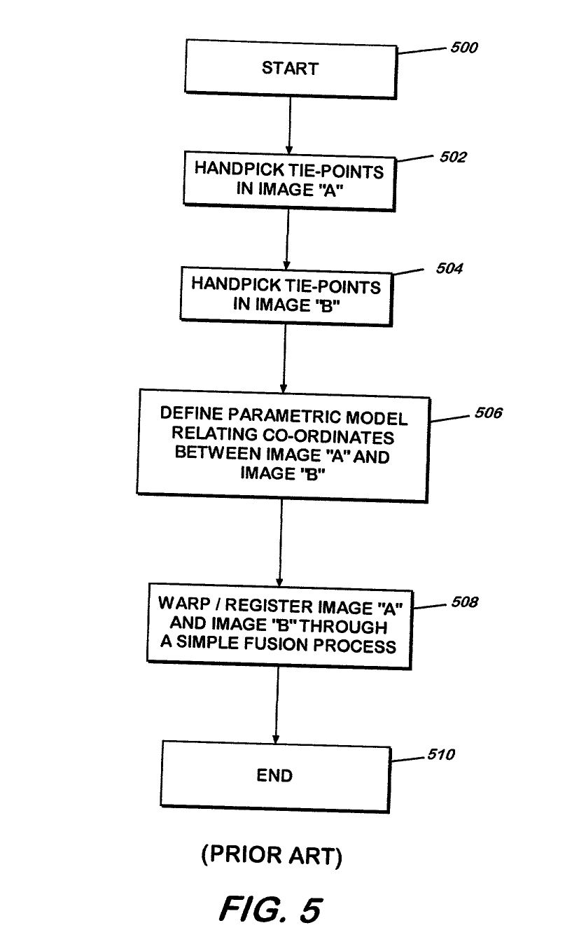

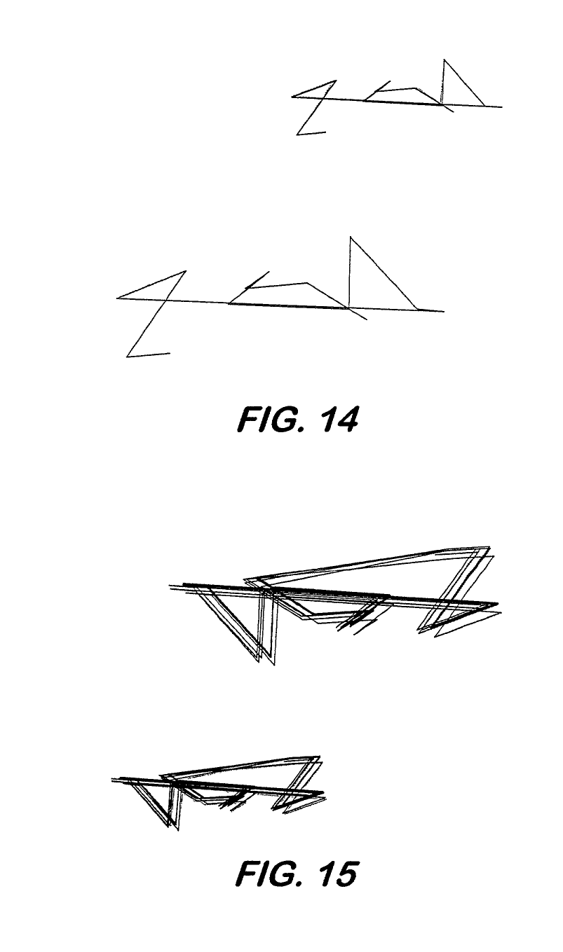

FIGS. 14 and 15 demonstrate the benefit of using optical flow to increase the total constellation of tie-points for subsequent registration. Specifically, FIG. 14 is an exemplary illustration showing a constellation of 12 tie-points relating to coordinates in visible and infrared imagery as identified in FIGS. 2 and 3 in accordance with an exemplary embodiment of the present invention. FIG. 15 is an exemplary illustration which shows a constellation of 84 tie-points generated by evaluating the original 12 tie-points across seven transformations of estimated optical flow in accordance with an exemplary embodiment of the present invention. As an alternative approach, one can presume the reference set of tie points b₀ to be absolute, while the aligned set of tie points a₀ are corrupted by some measurement error. Knowing that the success of any registration model depends on the accuracy in selecting this initial set of tie points, a corrective term e₀ is sought to generate a new set of tie points a′=a₀+e₀, subject to the implicit constraint that this choice minimizes the fitted registration error of tie points in all frames of the video sample. For example, this minimization can be implemented with an unconstrained Nelder-Mead simplex search.

In step-by-step form, the adaptive algorithm is initialized by the following steps:

1) Parametrically compute the optical flow of each separate sequence separately relative to a reference frame pair.

2) Pick a matching constellation of tie points in the reference pair of images.

Subsequently, an adaptive solution search is seeded with an initial guess e₀=[0 0].

1) For all frames, compute the positions of tie points b₀ and a₀+eᵢ after transformation by optical flow

2) For each frame, compute the total squared error resulting from an over-determined solution of the affiance registration problem as illustrated in equations (1) and (2)

3) Adjust the choice of eᵢ to minimize the total squared error over all frames of video.

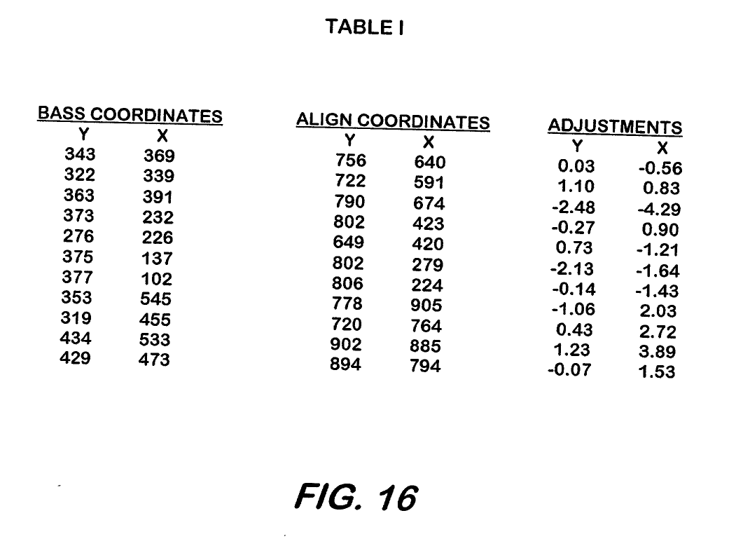

FIG. 16 illustrates an exemplary table showing initial set of tie-points and their final adjustments in accordance with an exemplary embodiment of the present invention.

| | | |
|---|---|---|
| Base Coordinates | Align Coordinates | Adjustments |

| | | | | | |
|---|---|---|---|---|---|
| Y | X | Y | X | Y | X |

| | | | | | |
|---|---|---|---|---|---|
| 343 | 369 | 756 | 640 | 0.03 | −0.56 |
| 322 | 339 | 722 | 591 | 1.10 | 0.83 |
| 363 | 391 | 790 | 674 | −2.48 | −4.29 |
| 373 | 232 | 802 | 423 | −0.27 | 0.90 |
| 276 | 226 | 649 | 420 | 0.73 | −1.21 |
| 375 | 137 | 802 | 279 | −2.13 | −1.64 |
| 377 | 102 | 806 | 224 | −0.14 | −1.43 |
| 353 | 545 | 778 | 905 | −1.06 | 2.03 |
| 319 | 455 | 720 | 764 | 0.43 | 2.72 |
| 434 | 533 | 902 | 885 | 1.23 | 3.89 |
| 429 | 473 | 894 | 794 | −0.07 | 1.53 |

The initial set of tie points, and final adjustments, are numerically given as follows:

The least squares solution of the model fit └1 A┘[R_{T}]=└B┘ is given by the matrix:

$${\underline{\underline{R}}}_{T} = [ \begin{matrix}- 134.75 & - 55.50 \\ 0.6367 & 0.0132 \\ - 0.0076 & 0.6517\end{matrix} ]$$

The error of this fit was found to be 31.43. The least squares solution of the model fit └1 (A+E)┘[R_{T}]=└B┘ is given by the matrix

$${\underline{\underline{R}}}_{T} = [ \begin{matrix}- 135.75 & - 51.38 \\ 0.6397 & 0.0105 \\ - 0.0084 & 0.6482\end{matrix} ]$$

The error of this fit was found to be 11.30. Final performance, registration of image A with respect to a base image B, is a function of both the initial tie-point selection, and accuracy of the optical flow estimation.

The approach of the present invention retains an advantage of generating a much larger set of flow-field vectors computed by an optical flow algorithm than that of a sample of tie-points. The optical flow provides an implicit stability constraint on any algorithmic adjustment of one set of tie points to better match another set subject to a warping registration model. Empirically, the optical flow can be computed with greater reliability than human-supervised tie-point selection, and therefore permits a more robust generalized coordinate map between pixels in each sensor than could be achieved by tie points alone.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for improving the accuracy of tie point registration of disparate imaging sensors by matching optical flow, the method comprising:
computing a set of parametric flow field matrices for at least two video sequences having consecutive image pairs for each separate imaging sensor;
determining a set of feature tie points for a reference frame pair;
evaluating locations of the feature tie points for all subsequent image pairs; and
redefining the tie point registration as simultaneous least squares solution to aligning all candidate tie points.

2. The method as in claim 1, wherein the set of parametric flow field matrices are defined as {Fᵢ^{A}, Fᵢ^{B}} i=1,2, . . . , n−1 relative to a video frame pair {A₀, B₀}.

3. The method as in claim 1, wherein the locations of the feature tie points for all subsequent image pairs is evaluated by the relation:
aᵢ=a₀+└1 a₀┘Fᵢ^{A}
i=1,2, . . . , n−1
bᵢ=b₀+[1 b₀]Fᵢ^{B}
where
a₀=tie points in frame A₀
b₀=tie points in frame B₀.

4. The method as in claim 1, wherein the imaging sensors are electro-optic imaging sensors.

5. The method as in claim 1, wherein the imaging sensors comprise a visible imager and an infrared imager.

6. A method for improving the accuracy of tie point registration of disparate imaging sensors by matching optical flow, the method comprising:
identifying multiple pairs of frames in a video sequence;
computing the optical flow of a plurality of video sequences;
computing positions of tie points across the plurality of video sequences; and
if one of the tie points has an initial error, adjusting the initial error such that error over all optical flow tie points is less than the initial error.

7. The method as in claim 6, wherein frame-to-frame estimation of a video scene motion of an individual imaging sensor is computed using shift estimation techniques.

8. The method as in claim 6, wherein motion of video sequences is characterized as flow field parameterized by geometry of imaging sensor motion and spatial distortions of imaging sensor optics.

9. A method for improving the accuracy of tie point registration of disparate imaging sensors by matching optical flow, the method comprising:
identifying a reference set of tie points b₀;
seeking a corrective term e₀ to generate a new set of tie points a′=a₀+e₀, such that the corrective term minimizes fitted registration error of tie points in all frames of a video sample.

10. The method as in claim 9, further comprising the steps of:
parametrically computing optical flow of each separate video sequence relative to a reference frame pair;
selecting a matching constellation of tie points in the reference frame pair;
for all frames, computing the positions of tie points b₀ and aᵢ=a₀+eᵢ after transformation by optical flow;
for each frame, computing the total squared error from an over-determined solution of affiance registration; and
adjusting the choice of eᵢ to minimize the total squared error over all frames of video to improve the accuracy of tie point registration of disparate imaging sensors.

11. The method as in claim 9, wherein the reference set of tie points b₀ is absolute.

12. A method for improving the accuracy of tie point registration of disparate imaging sensors by matching optical flow, the method comprising:
identifying an initial set of tie points to define a registration model to align a first image A onto a second base image B;
defining total registration error of the first and second images as a function of {a₀, b₀, Fᵢ^{A}, Fᵢ^{B} where i=}1, . . . (N−1); and
adjusting one set of tie points a₀ so as to minimize registration error such that error of {a₀′, b₀, Fᵢ^{A}, Fᵢ^{B}}<Error of {a₀, b₀, Fᵢ^{A}, Fᵢ^{B}}, where a₀′=a₀+e₀ and e₀ is a corrective term to generate a new set of tie points.

13. A method for improving the accuracy of tie point registration of disparate imaging sensors by matching optical flow, the method comprising:
given tie-points in image B as absolute, compute {B₀, B₁, . . . Bₙ} where B₁ . . . Bₙ represent flow estimates of a first image, and B₀ represents an original tie-point;
given A+ε₀ tie-points, compute {A₀, A₁, . . . Aₙ} where A₁, . . . Aₙ represents flow estimates from data of a second image and ε₀ represents a corrective term; and
adaptively choose ε₀ to minimize error between {A₀, A₁, . . . Aₙ} and {B₀, B₁, . . . Bₙ}.

14. An apparatus for improving the accuracy of tie point registration of disparate imaging sensors by matching optical flow, comprising:
means for identifying a reference set of tie points b₀;
means for seeking a corrective term e₀ to generate a new set of tie points a′=a₀+e₀, such that the corrective term minimizes fitted registration error of tie points in all frames of a video sample.

15. The apparatus as in claim 14, further comprising:
means for parametrically computing optical flow of each separate video sequence relative to a reference frame pair;
means for selecting a matching constellation of tie points in the reference frame pair;
means for computing the positions of tie points b₀ and a₁=a₀+eᵢ after transformation by optical flow;
means for computing the total squared error from an over-determined solution of affiance registration; and
means for adjusting the choice of eᵢ to minimize the total squared error over all frames of video to improve the accuracy of tie point registration of disparate imaging sensors.

16. The apparatus as in claim 14, wherein the reference set of tie points b₀ is absolute.

17. An apparatus for improving the accuracy of tie point registration of disparate imaging sensors by matching optical flow, comprising:
means for identifying multiple pairs of frames in a video sequence;
means for computing the optical flow of a plurality of video sequences;
means for computing positions of tie points across the plurality of video sequences; and
means for adjusting an initial error, if one of the tie points has the initial error, such that error over all optical flow tie points is less than the initial error.

18. The apparatus method as in claim 17, wherein frame-to-frame estimation of a video scene motion of an individual imaging sensor is computed using shift estimation techniques.

19. The apparatus as in claim 17, wherein motion of video sequences is characterized as flow field parameterized by geometry of imaging sensor motion and spatial distortions of imaging sensor optics.
